(19) United States
(12) Patent Application Publication
(10) Pub. No.: US 2021/0083386 A1
(43) Pub. Date: Mar. 18, 2021

(54) ANTENNA APPARATUS AND ELECTRONIC DEVICE

(71) Applicant: SHARP KABUSHIKI KAISHA, Sakai City (JP)

(72) Inventor: TETSUYA WATANABE, Sakai City (JP)

(73) Assignee: SHARP KABUSHIKI KAISHA, Sakai City (JP)

(21) Appl. No.: 17/006,487

(22) Filed: Aug. 28, 2020

(30) Foreign Application Priority Data
Sep. 12, 2019 (JP) 2019-166413

(51) Int. Cl. H01Q 7/00

(52) U.S. Cl. CPC H01Q 7/00; H01Q 1/243

(57) ABSTRACT

An antenna apparatus includes: an antenna coil configured to conduct short-range wireless communication by magnetic coupling; a conductive plate disposed to face the antenna coil, the conductive plate including an opening formed to be positioned to overlap with at least a portion of the antenna coil, a slit formed to extend from the opening toward an outside of the conductive plate, and a conductive member disposed along an edge, of the conductive plate, defining the opening; and a first insulating member disposed between the conductive plate and the conductive member.

### CROSS-REFERENCE TO RELATED APPLICATION

The present application claims priority from Japanese Application JP2019-166413, the content to which is hereby incorporated by reference into this application.

### BACKGROUND OF THE INVENTION

### 1. Field of the Invention

The present invention relates to an antenna apparatus and an electronic device.

### 2. Description of the Related Art

Resent years have seen an increase in electronic devices such as personal digital assistances (PDAs) including antenna apparatuses for short-range wireless communication. Moreover, some of the electronic devices including PDAs typically have, for example, a camera. Such an electronic device has a casing provided with an opening formed to expose the camera outside. The opening could be provided with an ornament of a conductive member such as metal.

For example, Japanese Unexamined Patent Application Publication No. 2017-163406 discloses an electronic device including: an optical module; a casing having a light-transparent window disposed across from the optical module; and an antenna apparatus disposed around the optical axis of a lens included in the optical module. The light-transparent window is surrounded by an annular conductive member.

### SUMMARY OF THE INVENTION

In the electronic device disclosed in Japanese Unexamined Patent Application Publication No. 2017-163406, the antenna apparatus includes a coil conductor generating a magnetic flux. Unfortunately, the magnetic flux causes an eddy current running in the annular conductive member. The eddy current generates an unnecessary magnetic field from the annular conductive member, impairing a magnetic field generated from the antenna apparatus. Moreover, the casing of the electronic device could be provided with, for example, a slit so that the whole casing would be used as an antenna of the antenna apparatus. However, if the slit is partially overlapped with the annular conductive member, an induced current caused by the magnetic flux of the coil conductor mainly runs in the annular conductive member. This problem does not allow the whole casing to be used as an antenna, making it difficult to ensure excellent antenna characteristics.

An aspect of the present invention is to provide an antenna apparatus including a conductive material disposed along an edge, of a conductive plate, defining an opening, while achieving excellent antenna characteristics.

In order to solve the above problems, an antenna apparatus according to an aspect of the present invention includes: an antenna coil configured to conduct short-range wireless communication by magnetic coupling; a conductive plate disposed to face the antenna coil, the conductive plate including an opening formed to be positioned to overlap with at least a portion of the antenna coil, a slit formed to extend from the opening toward an outside of the conductive plate, and a conductive member disposed along an edge, of the conductive plate, defining the opening; and a first insulating member disposed between the conductive plate and the conductive member.

An aspect of the present invention can provide an antenna apparatus including a conductive material disposed along an edge, of a conductive plate, defining an opening, while achieving excellent antenna characteristics.

### BRIEF DESCRIPTION OF THE DRAWINGS

FIG. 1 is a plan view illustrating a back face of a smartphone according to a first embodiment;

FIG. 2 is a plan view illustrating an internal structure of a portion illustrated in an area A in FIG. 1;

FIG. 3 is a perspective view illustrating a metal ornament of the smartphone according to the first embodiment;

FIG. 4 is a cross-sectional view, taken along arrows B-B in FIG. 3; and

FIG. 5 is a perspective view illustrating a metal ornament of a smartphone according to a second embodiment.

### DETAILED DESCRIPTION OF THE INVENTION

### First Embodiment

Configuration of Smartphone

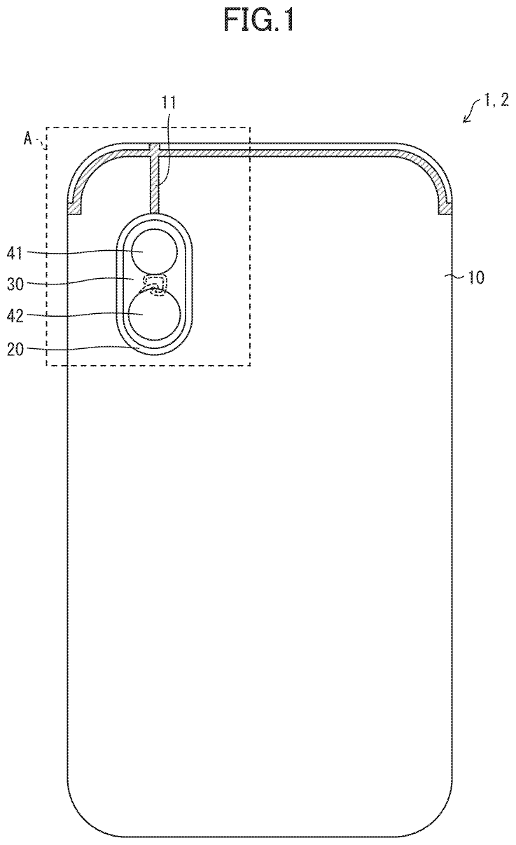

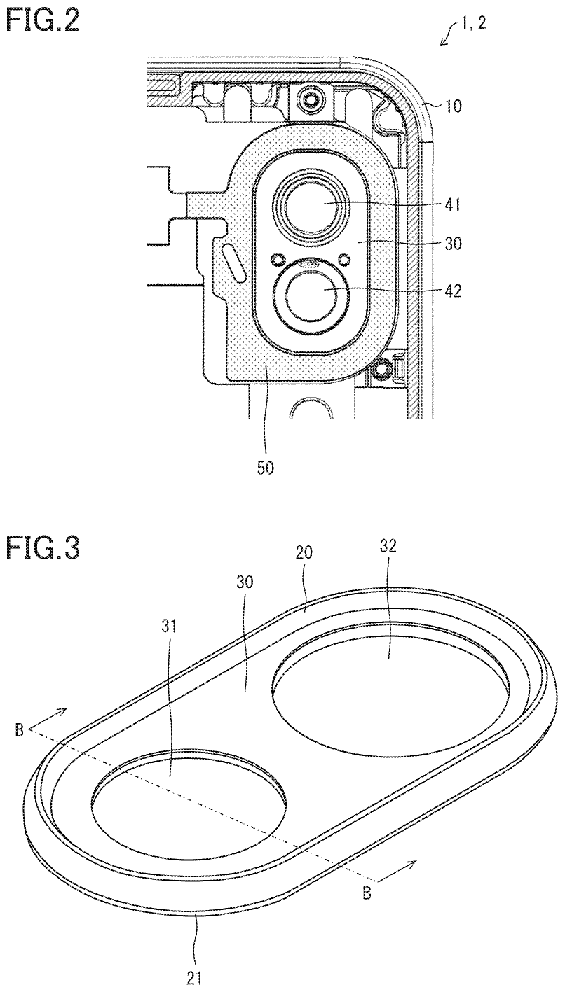

Described below is an embodiment of the present invention, with reference to FIGS. 1 to 4. As illustrated in FIG. 1, a smartphone (an electronic device) 1 includes: an antenna apparatus 2; a camera 41; and a camera 42. FIG. 2 illustrates an internal structure, of a portion illustrated in an area A in FIG. 1, viewed from a not-shown display surface of the smartphone 1. In FIG. 2, the antenna apparatus 2 includes: a casing (a conductive plate) 10; and an antenna coil 50. The casing 10 and the antenna coil 50 included in the antenna apparatus 2 are members of the smartphone 1. Hence, described below first are components of the smartphone 1, followed by the antenna apparatus 2. Note that, in this Specification, a surface of the not-shown display included in the smartphone 1 is referred to as a “display surface”, a surface in back of the display surface as a “back surface”, and a face on a side of the display surface and the back surface as a “side surface.”

(Casing)

The casing 10 of the smartphone 1 is formed of a conductive material. Examples of the conductive material include, but not limited to, aluminum, stainless, and liquid metal. The conductive material may be a material other than metal, such as carbon. The casing 10 integrally forms the side surface and the back surface of the smartphone 1 in a single piece. The casing 10 is shaped into a co-called bathtub. Note that the shape of the casing 10 shall not be limited to the bathtub shape. Alternatively, for example, the side surface and the back surface of the smartphone 1 may be formed of different members. In such a case, the member forming the back surface of the casing 10 of the smartphone 1 functions as a conductive plate according to an embodiment of the present invention. Moreover, the casing 10 may have a surface coated with a conductive material such as metal, so that only the coated surface may be conductive. Furthermore, the casing 10 may include an insulating portion.

The casing 10 includes: a slit 11 and a camera hole (an opening) 30. The slit 11 is formed to extend from the camera hole 30 toward the outside of the casing 10. A portion, of the casing 10, in which the slit 11 is formed may be insulating. Hence, the slit 11 may be provided with, for example, an insulating material. Alternatively, the slit 11 may be a space. Examples of the insulating material provided to the slit 11 include, but not limited to, a glass material and such resin materials as polycarbonate, acrylonitrile butadiene styrene (ABS), acrylonitrile-styrene (AS), high-density polyethylene, polystyrene, and polypropylene.

The camera hole 30 is formed to expose lenses of the cameras 41 and 42 outside of the smartphone 1. The cameras 41 and 42 obtain a still image and/or a moving image. The camera hole 30 is provided with, but not limited to, two cameras, namely, the cameras 41 and 42. Alternatively, the camera hole 30 may be provided with one camera, or three or more cameras.

Moreover, the camera hole 30 may be an opening formed to be provided with a member other than the cameras. An example of the opening includes, but not limited to, a hole to be provided with an insulating material only to allow the casing 10 to have an insulating portion. In such a case, the insulating material to be disposed in a position where the hole is formed may be the same as the insulating material disposed to the slit 11.

Metal Ornament

The casing 10 includes a metal ornament 20 disposed along an edge, of the casing 10, defining the camera hole 30. The metal ornament 20 is disposed to decorate and protect the camera hole 30. Alternatively, the metal ornament 20 may be disposed for other purposes. The metal ornament 20 is annular along the shape of the edge, of the casing 10, defining the camera hole 30. The shape of the metal ornament 20 may be adjusted as appropriate in conformity with the shape of the edge, of the casing 10, defining the camera hole 30.

The metal ornament 20 is formed of a conductive material such as metal. The conductive material may be the same as that of the above casing 10. The metal ornament 20 is disposed to extend from the casing 10 toward the outside of the casing 10. Hence, the metal ornament 20 may be formed of a material, such as metal, which excels in, for example, strength and wear resistance in order to reduce damage to the metal ornament 20.

Formed inside the metal ornament 20 in planar view are a camera window 31 corresponding to the camera 41 and a cameral window 32 corresponding to the camera 42. One or three or more of these camera windows may be formed, depending on the number of cameras included in the smartphone 1. Alternatively, the camera windows do not have to be formed at all. The camera windows, provided inside the metal ornament 20, may preferably be formed of an insulating material. The insulating material may be the same as the insulating material disposed to the above slit 11.

As illustrated in FIG. 3, a first insulating member 21 is disposed, on the metal ornament 20, close to the casing 10; that is, between the casing 10 and the metal ornament 20. The first insulating member 21 is formed of an insulating material. The insulating material may be the same as the insulating material disposed to the above slit 11. The first insulating member 21 cuts electrical connection between the casing 10 and the metal ornament 20.

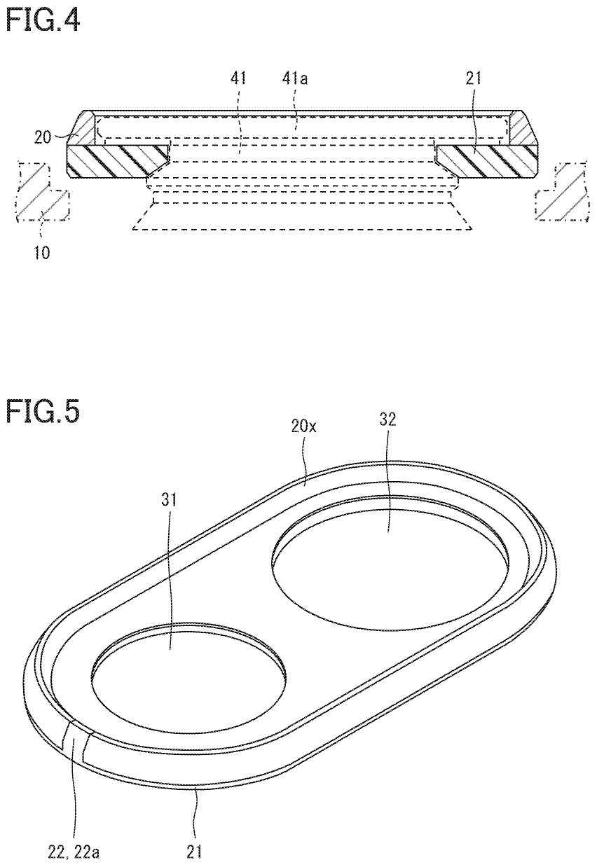

FIG. 4, which is a cross-sectional view taken along arrows B-B in FIG. 3, schematically illustrates a cross-sectional view of the metal ornament 20. For reference purposes, dash-dot-dash lines indicate a position of the casing 10 and dot-dash lines indicate positions of the camera 41 and a lens cover 41a of the camera 41, when the metal ornament 20 is disposed to the casing 10. As illustrated in FIG. 4, the first insulating member 21 is disposed between the casing 10 and the metal ornament 20. The casing 10 does not have direct contact with the metal ornament 20. Hence, no electrical connection is made between the casing 10 and the metal ornament 20.

Antenna Coil

The antenna coil 50 is a member to conduct short-range wireless communication by magnetic coupling. As illustrated in FIG. 2, the antenna coil 50 is disposed inside the smartphone 1 to face the casing 10. Moreover, the antenna coil 50 is disposed to overlap on a plane with the position in which the camera hole 30 is formed. In other words, the camera hole 30 is formed, on the casing 10, to be positioned to overlap with at least a portion of the antenna coil 50.

The antenna coil 50, which is a conductive line formed of a conductive member, is disposed on an insulating base material. The conductive line is wound around the camera hole 30 to surround an area in which the camera hole 30 is formed. The antenna coil 50 includes a coil opening surrounded, but not provided, with the conductive line. In the smartphone 1, the coil opening is formed to be positioned to overlap with the cameral hole 30 on a plane. However, the position of the coil opening is not limited to such a position. Alternatively, the coil opening may be formed to be positioned to at least partially overlap with the position in which the camera hole 30 is formed.

Hence, the antenna coil 50 needs to at least partially overlap with the position of the opening formed on the casing 10. The smartphone 1 according to this embodiment uses the camera hole 30 as the opening. Such a feature eliminates the need of an opening, other than the camera hole 30, for placing the antenna coil 50, making it possible to place the antenna coil 50 while maintaining the smartphone 1 in good appearance.

A direction of an axis about which the conductive line turns is substantially the same as a normal direction of a plane on which the antenna coil 50 of the casing 10 is disposed. The antenna coil 50 may be a loop coil of the conductive line with either one turn or two or more turns. The number of turns of the conductive line may be adjusted as appropriate, depending on antenna characteristics required for the antenna apparatus 2. Note that the antenna characteristics will be described later.

Antenna Apparatus

Configuration of Antenna Apparatus

The antenna apparatus 2 according to this embodiment includes: the antenna coil 50; and the casing 10 provided with the antenna coil 50. That is, the smartphone 1 includes the antenna apparatus 2 in which the substantially whole casing 10 functions as an antenna. The casing 10 and the antenna coil 50 have been already described above, and will not be elaborated upon here. Note that the antenna apparatus 2 included in the smartphone 1 does not have to use the substantially whole casing 10 as an antenna.

For example, in the antenna apparatus according to an embodiment of the present invention, the casing of the smartphone may have a portion formed of a conductive material. The conductive material portion may function as an antenna. Moreover, the antenna apparatus according to an embodiment of the present invention may be incorporated into, for example, the smartphone according to an embodiment of the present invention. Specific functions of the antenna apparatus 2 will be described later in detail.

Note that electronic devices including the antenna apparatus 2 are not limited to the smartphone 1. Examples of such electronic devices include, but not limited to, cellular phones other than the smartphone 1, PDAs, and tablet terminals.

Functions of Antenna Apparatus

The antenna apparatus 2 functions as a transmitter-receiver to conduct short-range wireless communication by magnetic coupling. Examples of the short-range wireless communication to be used for the antenna apparatus 2 include, but not limited to, such standards as Felica (Registered), Mifare (Registered), and Near Field Communication (NFC). Note that, in this Specification, the performance of the antenna apparatus 2, such as the communicable maximum range and communication stability, is referred to as “antenna characteristics.” Here, “high” or “good” antenna characteristics indicate that the antenna apparatus 2 has a long communicable maximum range and excels in communication stability.

In the antenna apparatus 2, a current runs through, and generates a magnetic flux from, the antenna coil 50. The magnetic flux generates an induced current running through an edge, of the casing 10, defining the camera hole 30 positioned to at least partially overlap with the antenna coil 50 on a plane. The induced current runs in an opposite direction to the current running through the antenna coil 50. Thanks to advantageous effects of the slit 11, the induced current running through the casing 10 runs through the edge, of the casing 10, defining the camera hole 30 and the slit 11, and further runs around an outer edge of the casing 10. Since the casing 10 is larger in area than the antenna coil 50, the magnetic flux generated by the induced current from the casing 10 is significantly larger than the magnetic flux generated from the current running through the antenna coil 50. Hence, the magnetic flux generated from the antenna apparatus 2 travels through a wide range. Thus, the antenna apparatus can ensure high antenna characteristics.

Here, similar to the casing 10, the metal ornament 20 is also formed of a conductive material. Furthermore, the metal ornament 20 is disposed along the edge, of the casing 10, defining the camera hole 30. Hence, if the casing 10 and the metal ornament 20 are electrically connected together, the induced current causes the metal ornament 20, formed annular, to generate an eddy current. Thus, the induced current is less likely to run through the outer edge of the casing 10. In this embodiment, however, the first insulating member 21 is disposed between the casing 10 and the metal ornament 20. The first insulating member 21 cuts the electrical connection between the casing 10 and the metal ornament 20. Hence, despite the metal ornament 20, the induced current runs through the outer edge of the casing 10, substantially independently from the induced current running through the metal ornament 20.

Here, it is more preferable as the casing 10 and the metal ornament 20 are farther distant from each other. The metal ornament 20 is disposed along the edge, of the casing 10, defining the camera hole 30. Hence, when the magnetic flux is generated from the antenna coil 50, the induced current runs also through the metal ornament 20, in addition to the casing 10, in an opposite direction to the current running through the antenna coil 50. The magnetic flux generated from the eddy current running through the metal ornament 20 also generates the induced current in the casing 10. However, the induced current due to the magnetic flux generated from the antenna coil 50 and the induced current due to the magnetic flux generated from the metal ornament 20 run in opposite directions. Hence, the induced current actually generated in the casing 10 is attenuated.

If the casing 10 and the metal ornament 20 are sufficiently distant from each other, the magnetic flux generated from the metal ornament 20 is less likely to affect the casing 10. The magnetic flux generated from the antenna coil 50 disposed to face the casing 10 is also less likely to affect the metal ornament 20 as the casing 10 and the metal ornament 20 are farther distant from each other. Hence, the eddy current running through the metal ornament 20 is attenuated further as the casing 10 and the metal ornament 20 are distant farther from each other. Accordingly, the magnetic flux generated from the metal ornament 20 becomes smaller. The distance between the casing 10 and the metal ornament 20 may be adjusted as appropriate in designing to ensure desired antenna characteristics.

As can be seen, because of the advantageous effects of the first insulating member 21, the antenna apparatus 2 provided with the metal ornament 20 can ensure excellent antenna characteristics equal to those of an antenna apparatus without the metal ornament 20.

### Second Embodiment

Described below is another embodiment of the present invention, with reference to FIG. 5. Note that, for the sake of description, identical constituent features between this embodiment and the preceding embodiment have the same reference signs. Such constituent features will not be repeatedly elaborated. The antenna apparatus 2 in this embodiment is different from the antenna apparatus 2 in the first embodiment in that the former includes a metal ornament 20x including a clearance 22.

The metal ornament 20x includes the clearance 22. The clearance 22 is formed to partially cut a loop of the metal ornament 20x. In other words, the clearance 22 is formed to cut electrical connection in the metal ornament 20x. Hence, the clearance 22 may have any given width in a circumferential direction of the metal ornament 20x if the width is sufficiently large to cut the electric connection in the metal ornament 20x. Moreover, the clearance 22 may be formed in any given portion of the metal ornament 20x. Furthermore, the clearance 22 of the metal ornament 20x may include a single clearance 22 or a plurality of clearances 22.

In a position in which the clearance 22 is formed, a second insulating member 22a is disposed. The second insulating member 22a is formed of an insulating material. The insulating material may be the same as the insulating material disposed to the above slit 11. The second insulating member 22a disposed in the clearance 22 allows the clearance 22 to easily and reliably cut the electrical connection in the metal ornament 20x. Such a feature makes it possible to easily reduce the width of the clearance 22 in the circumferential direction of the metal ornament 20x. Moreover, the metal ornament 20x and the second insulating member 22a are continuously formed together in the circumferential direction of the metal ornament 20x, easily maintaining the metal ornament 20x in good appearance. Note that the clearance 22 does not have to be provided with the second insulating member 22a.

The clearance 22 formed in the metal ornament 20x cuts the electrical connection in the metal ornament 20x. Hence, even if a magnetic flux is generated by a current running through the antenna coil 50, an induced current running through the metal ornament 20x does not become an eddy current. Thus, no magnetic flux due to the eddy current is generated from the metal ornament 20x. As a result, there is no risk of the magnetic flux, to be generated by the eddy current, impairing an induced current generated in the casing 10 by a magnetic flux generated from the antenna coil 50. Such a feature easily secures the antenna characteristics of the antenna apparatus 2 even if the distance between the casing 10 and the metal ornament 20x is decreased.

Hence, the antenna apparatus 2 may be designed more freely. Furthermore, the smartphone 1 including the antenna apparatus 2 can be produced thinner easily.

### SUMMARY

An antenna apparatus according to a first aspect of the present invention includes: an antenna coil configured to conduct short-range wireless communication by magnetic coupling; a conductive plate disposed to face the antenna coil, the conductive plate including an opening formed to be positioned to overlap with at least a portion of the antenna coil, a slit formed to extend from the opening toward an outside of the conductive plate, and a conductive member disposed along an edge, of the conductive plate, defining the opening; and a first insulating member disposed between the conductive plate and the conductive member.

In the above configuration, the conductive plate, provided with the antenna coil for short-range wireless communication, has the edge defining the opening and further provided with the conductive member. The conductive material is, for example, a member to decorate or protect the edge. The first insulating member is disposed between the conductive plate and the conductive member. Hence, an induced current generated by a magnetic flux due to a current running through the antenna coil runs independently between the conductive plate and the conductive member. Hence, because of advantageous effects of the slit, the direction of the induced current widely running through an outer edge of the conductive plate is not affected by the conductive member. Hence, even if the antenna apparatus includes the conductive member, the above feature makes it possible to efficiently radiate a magnetic field from the whole conductive plate.

A second aspect of the present invention is directed to the antenna apparatus according to the first aspect, wherein the conductive member may include a clearance to cut electrical connection in the conductive member. In the above configuration, the conductive member includes a clearance. The clearance cuts electrical connection in the conductive member, such that the conductive member does not conduct the eddy current. Hence, the magnetic flux due to the eddy current is not generated from the conductive member, such that there is no risk of the magnetic flux, due to the eddy current, impairing an induced current generated in the conductive plate.

A third aspect of the present invention is directed to the antenna apparatus according to the second aspect. The antenna apparatus may further include a second insulating member disposed in a position in which the clearance is formed. In the above configuration, the second insulating member is disposed in the position where the clearance is formed. Such a feature makes it possible to easily and reliably cut the electrical connection in the conductive member, contributing to reliable reduction in the eddy current running through the conductive member. Moreover, the conductive member and the second insulating member are continuously formed together, easily maintaining the conductive member in good appearance.

An electronic device according to a fourth aspect of the present invention includes the antenna device according to any one of the first to third aspects.

While there have been described what are at present considered to be certain embodiments of the invention, it will be understood that various modifications may be made thereto, and it is intended that the appended claim cover all such modifications as fall within the true spirit and scope of the invention.

What is claimed is:

1. An antenna apparatus, comprising:
an antenna coil configured to conduct short-range wireless communication by magnetic coupling;
a conductive plate disposed to face the antenna coil, the conductive plate including
an opening formed to be positioned to overlap with at least a portion of the antenna coil,
a slit formed to extend from the opening toward an outside of the conductive plate, and
a conductive member disposed along an edge, of the conductive plate, defining the opening; and
a first insulating member disposed between the conductive plate and the conductive member.

2. The antenna apparatus according to claim 1, wherein
the conductive member includes a clearance configured to cut electrical connection in the conductive member.

3. The antenna apparatus according to claim 2, further comprising
a second insulating member disposed in a position in which the clearance is formed.

4. An electronic device including the antenna device according to claim 1.
